(19) United States
(12) Patent Application Publication
(10) Pub. No.: US 2015/0202752 A1
(43) Pub. Date: Jul. 23, 2015

(54) COMPONENT FOR A BIT DRIVING TOOL

(71) Applicant: THUNDER INNOVATIONS INC., Calgary (CA)

(72) Inventors: Alan Kent FARRELL, Salt Lake City, UT (US); Binh PHAM, Cottonwood Heights, UT (US)

(21) Appl. No.: 14/591,123

(22) Filed: Jan. 7, 2015

Related U.S. Application Data
(60) Provisional application No. 62/057,528, filed on Sep. 30, 2014.
(60) Provisional application No. 61/928,801, filed on Jan. 17, 2014.

(51) Int. Cl. B25B 23/00; B25B 23/16; B25G 1/08; B25B 15/00

(52) U.S. Cl. CPC B25B 23/0035; B25B 15/00; B25B 23/16; B25G 1/085

(57) ABSTRACT

A component of a bit driving tool is presented, having a mid-chamber, telescopically received in an outer chamber. A bit storage chamber is formed in the mid-chamber, surrounding and rotatable about a central. A central rod extends through and out of the outer chamber. A dual lever arm comprising a first magnetic end and a second end is pivotably connected to the central rod such that the dual lever arm pivots into and out of axial alignment with the central bore. Telescopic extension of the mid-chamber out of the outer chamber positions the dual lever arm to magnetically connect with a rear end of a bit stored in the bit storage chamber and telescopic retraction of the component pivots the bit radially inwardly into the central chamber and wherein further telescope retraction of the component pushes the bit through the central chamber until the bit extends out of the component.

### FIELD OF THE INVENTION

The present invention relates to a component for a screw driver or drill that allows for ease of bit replacement.

### BACKGROUND

Drills and screwdrivers, both powered and manual are well known historically as tools for drilling holes and driving threaded screws into surfaces for any number of construction purposes.

Although some manual screwdrivers and even drills are built with a single, integral screw or drill bit, it is more commonly preferred that the driver or drill be able to accommodate any number of bits, to allow for a variety of sizes of holes to be drilled, or a variety of sizes or types of screws to be driven. Bits are often stored in an external bit storage magazine from which a desired bit can be selected and loaded into the screwdriver or drill chuck. Alternately, many screw drivers comprise a bit storage magazine in the form of a hollow driver handle with multiple chambers for storing the bits. Bits can be selected and removed from the handle end and then loaded into the chuck end of the driver.

The need to first remove and then load bits from an external or integrated magazine often leads to loss of bits and additional time.

Some prior art drills and screwdrivers have been designed in which bits may be stored in chamber that is integral with the tool, and in which bits may be selected and then pushed through chamber and out through the chuck where it is locked or otherwise prevented from rotating inside or sliding out of the chuck.

However in most such cases, the bit storage chamber is mis-aligned with the central chamber and chuck of the tool. In such cases, bit selection is performed by rotating the bit storage chamber until the desired bit alignes with an opening leading to the central chamber, and then the bit is pushed through the opening, into the chamber and out through the chuck. The arrangement is not unlike a bullet chamber in relation to the barrel of a gun.

U.S. Pat. No. 7,086,314 teaches a tool with a bit storage chamber that is rotatable about a slotted, apertured core of the tool. The tool comprises a lever arm pivotally coupled to a core to magnetically attract the desired bit from the chamber and a magnet-tipped push rod to push the bit through a shaft to protrude through the chuck. The magnetic lever arm shares a limited area of contact with bit and is thus limited to the size of bits that can be magnetically attracted and pulled into the core.

A need and interest therefore exists in the art to develop improved drill and screwdriver assemblies of simple internal design that allow for rapid changing of bits.

### SUMMARY

A component of a bit driving tool is presented. The component comprises a mid-chamber, telescopically received in an outer chamber, the mid-chamber and the outer chamber surrounding a central bore. A bit storage chamber is formed in the mid-chamber, surrounding and rotatable about the central bore and comprising one or more bit storage compartments. A central rod extends through and out of the outer chamber, said central rod being axially movable through central bore when the mid-chamber is telescopically retracted into the outer chamber. A dual lever arm comprising a first magnetic end; and a second end is pivotably connected to the central rod such that the dual lever arm pivots into and out of axial alignment with the central bore. Telescopic extension of the mid-chamber out of the outer chamber positions the magnetic end of the dual lever arm to magnetically connect with a rear end of a bit stored in the bit storage chamber and telescopic retraction of the component pivots the magnetic end and the magnetically connected bit radially inwardly into the central chamber and wherein further telescope retraction of the component pushes the central rod, the dual lever arm, the magnetic end and the bit axially through the central chamber until the bit extends out of the component.

### BRIEF DESCRIPTION OF THE DRAWINGS

The present invention will now be described in greater detail, with reference to the following drawings, in which:

FIG. 1 is a cross sectional view of the component of the present invention in an opened position;

FIG. 2 is a cross sectional view of the component of the present invention in a bit engaging position;

FIG. 3 is a cross sectional view of the component of the present invention in a closed position

FIG. 4 is a side view of one embodiment of the magnetic end of the present invention; and

FIG. 5 is a perspective view of one embodiment of the magnetic end of the present invention.

### DESCRIPTION OF THE INVENTION

The invention provides an insert or internal component for a screwdriver or drill. The component houses screw bits or drill bits that can be changed without the need to individually remove and load the bits into the tool opening. Changing of bits can be performed with the component installed in the screwdriver or drill.

The component is rotatably received in the screwdriver or drill. More preferably, rotation of the component is accommodated by a series of ball bearings between the rotating component and the stationary outer drill body. When the component is in an open position, it can freely move or spin. When the component is moved to a closed position, it is locked against spinning unless the drill is activated.

The term drill is used in the context of the present invention to generally describe any manual or powered tool used to drill holes or drive screws or other fasteners. For the purposes of the present invention the term drill is intended to encompass any such device that can handle standard fastener bits. The bits of the present invention can be drill bits or screwdriver bits, depending on the applications. Any number of sizes or shapes of such bits can be used with the component of the present invention. Most preferably the bits are 2″ bits. Shorter or longer bits can also be accommodated.

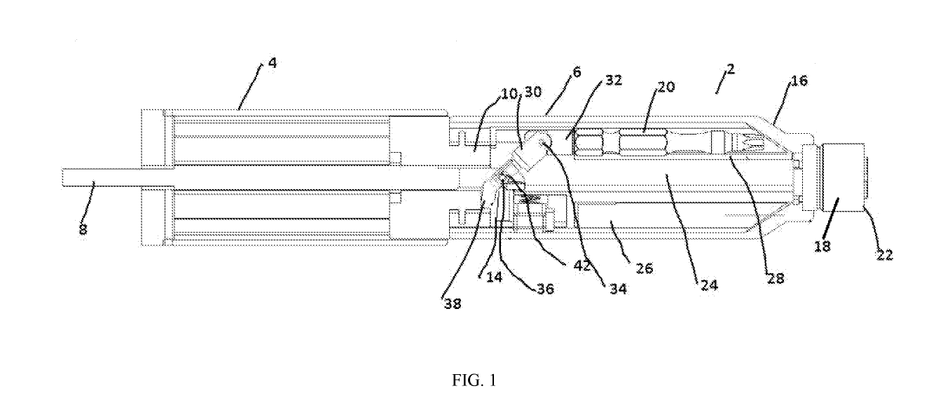

The component of the present invention is shown in FIGS. 1 to 3 in various positions. With reference to these figures, the component 2 comprises a mid-chamber 6 having first end that is telescopically received into a second end of an outer chamber 4. When the mid-chamber 6 is extended out of the outer chamber 4, it is rotatable. When the mid-chamber 6 is pushed into the outer chamber it is locked against independent rotation. Any number of known means may be employed to prevent relative rotation between the mid-chamber and the outer chamber 4, including complimentary profiles on an inner surface of the outer chamber 4 and the on an outer surface of the mid-chamber 6 that interact to prevent relative rotation. Such profiles can include but are not limited to complimentary ribs and slots, ridges and valleys, or complimentary faceted surfaces.

An inner chamber 10 sits inside both the mid-chamber 6 and the outer chamber 4. The inner chamber does not rotate with the mid-chamber and is rotationally locked together with the outer chamber 4.

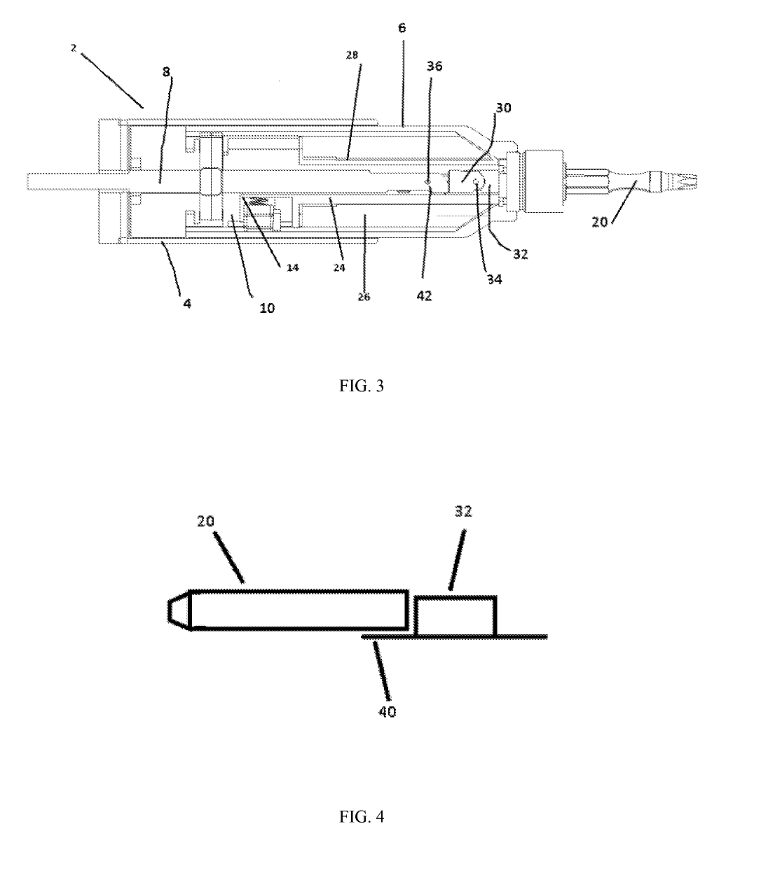

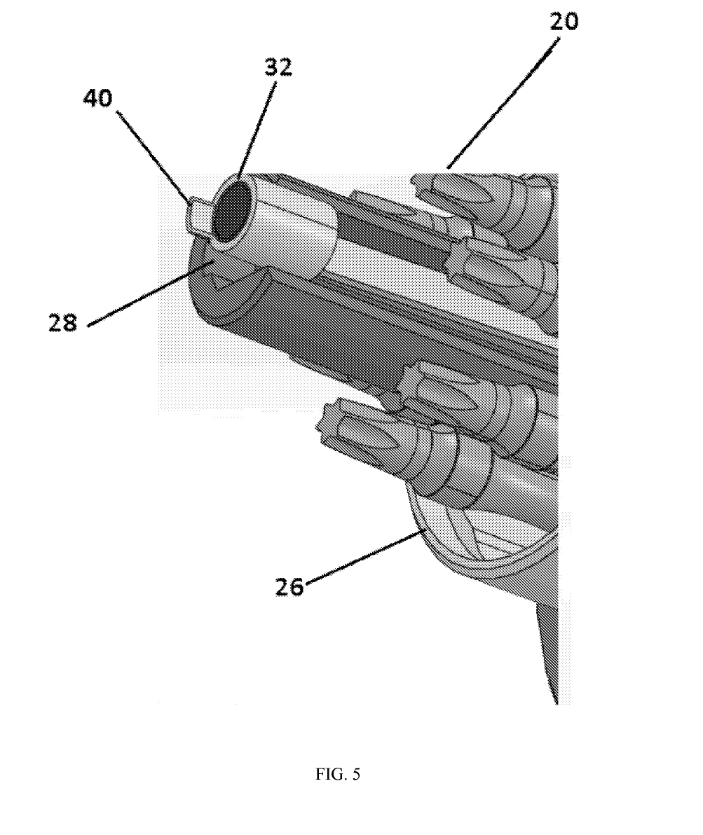

A central rod 8 extends through a central bore 24 of the component from the inner chamber 10 to the outer chamber 4 and extends out of and is rotationally locked to the first end of the outer chamber 4. The portion of the central rod 8 that extends from the first end of the outer chamber 4 is connectable to a drill or other drive means to rotate the central rod 8 and thus cause rotation of the outer chamber 4, inner chamber 10 and mid-chamber 6 when a bit has been engaged, the position shown in FIG. 3.

A locking tip 18 extends from a second end of the mid-chamber 6 to receive bits 20. The locking tip 18 can receive bits 20 that are pushed through the mid-chamber 6 or which are loaded, manually or otherwise, into a first end 22 of the locking tip 18.

The mid-chamber 6 comprises a bit storage chamber 26 that circumferentially surrounds the inner chamber 10 and a central bore 24 of the component 2. The bit storage chamber 26 comprises one or more spaces for housing one or more bits 20. Rotation of the mid-chamber 6 rotates the bit storage chamber 26 around the central bore 24 for selection of a desired bit 20. A longitudinal slot 28 in the central bore 24 allows for passage of a desired bit 20 from the bit storage chamber 26 into the central bore 24.

The second end of the mid-chamber 6 preferably comprises an angled profile 16 that assists in guiding bits 20 into the radial center of the component 2 and out of the locking tip 18.

The inner chamber 10 further comprises a dual lever arm 30. The dual lever arm 30 comprises a first pivot point 36, axially aligned with the central bore 24, and pivotably connecting the dual lever arm 30 to the central rod 8. The dual lever arm 30 further comprises a magnetic end 32 that is aligned with the longitudinal slot 28. Preferably the magnetic end is pivotable by means of a second pivot joint 34. The magnetic end 32 and the second end 38 are opposite one another and pivot radially towards and away from the central bore 24 of the component 2, about first pivot point 36.

With reference to FIG. 1, to load a bit 20, the mid-chamber 6 is telescopically extended from the outer chamber 4, thereby allowing rotation of the mid-chamber 6, independent of the outer chamber 4 and the inner chamber 10. Bit selection is made by rotation of the mid-chamber 6, thereby rotating the bit storage chamber 26 about the central bore 24 until the desired bit 20 aligns with slot 28.

Preferably the component 2 of the present invention comprises means for the user to identify and select a bit 20 of choice. In one embodiment, the mid-chamber 6 can be made of a transparent or translucent material that allows visual identification of the bits within the bit storage chamber 26. In another embodiment, an audio, visual or tactile means can be used to confirm alignment of the desired bit 20 with the slot 28. For example, a detent can be incorporated into mid-chamber 6 that provides a tactile or audio ‘click’ or ‘snap’ each time a bit storage space is aligned with the slot 28. It would be well understood by a person of skill in the art that any number of means can possibly be used to identify a desired bit or to confirm alignment of said bit 20 with slot 28.

In a further preferred embodiment, mid-chamber 6 can be a removable piece of the present invention, allowing for different mid-chambers, each having its own bit storage chamber with one or more bits, to be loaded into to drill component 2 in order to provide different bits for use with the present invention.

The magnet end 32 of the dual lever arm aligns with the bit storage chamber 26. Preferably, the dual lever arm 30 comprises a biasing means 42 for biasing the magnetic end 32 of the dual lever arm 30 to the bit storage chamber 26 rather than the central bore 24. More preferably the biasing means 42 comprises a biasing spring at the first pivot point 36 and mating shoulder 14 on the central rod 8.

When the desired bit is aligned with the slot 28, the magnetic end 32 of the dual lever arm 30 becomes magnetically attracted to a proximal end of the bit 20 and thereby catches the bit 20. In a further preferred embodiment, as illustrated in FIGS. 6 and 7, the magnetic end 32 may optionally include a protrusion 40 that may serve to mechanically engage the bit 20, in addition to the magnetic engagement provided by the magnetic end 54.

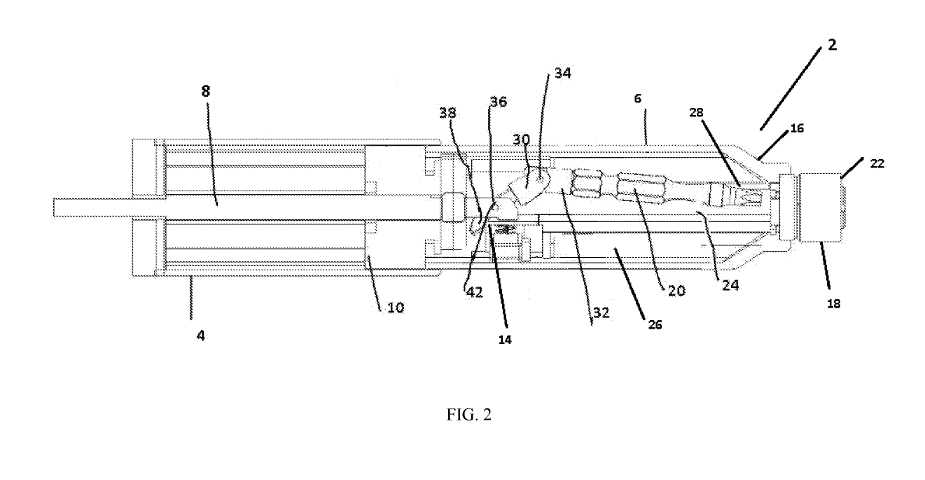

The mid-chamber 6 can then be retracted into outer chamber 4. A first stage of this retraction is shown in FIG. 2, which illustrate an engaged position of the component 2 of the present invention. In the engaged position, at least partial retraction of the mid-chamber 6 into the outer chamber 4 causes the central rod 8 to travel axially in the direction of the locking tip 18. The second end 38 of the dual lever arm correspondingly travels along shoulder 14, thereby overcoming the biasing force of biasing means 42 and causing the dual lever arm 30 to pivot about first pivot point 36. Rotation of the dual lever arm about first pivot point 36 causes magnetic end 32 of the dual lever arm 30, with bit 20 attracted thereto, to pivot into alignment with the central bore 24, thus pulling the bit 20 through slot 28 and into central bore 24. The optional protrusion 40 on the magnetic end 32 may preferably serve to assist in engaging and guiding the bit 20 through the central bore 24.

Optionally a second pivot point 34 is present at the magnetic end and serves to maintain alignment of the magnetic end 32 with a rear end surface of the bit 20, thereby maximizing contact and magnetic attraction between the magnetic end 32 of the dual lever arm 30 and the bit 20.

As the mid-chamber 6 is retracted into the outer chamber 4, the central rod 8 continues to travel axially into central bore 24, thereby also pushing dual lever arm 30 with the bit 20 magnetically linked to the magnetic end 32, through the central bore 24. The component 2 is illustrated in its fully engaged position in FIG. 3, in which the bit 20 has been pushed through the central bore 24 and out to the locking tip 18, from which the bit 20 protrudes. The locking tip 18 preferably comprises locking means 46 (not shown) for preventing the bit from rotating within the locking tip 18 or from falling out of the locking tip 18.

In use, the central rod 8 is connected into a drill or similar driver device. Rotational force powered by the driver device is transmitted to the central rod 8. The central rod 8 is rotationally fixed to the outer chamber 4, which is in turn rotationally fixed to the inner chamber 10 and to mid-chamber 6. The mid-chamber 6 is further rotationally fixed to the locking tip 18, which is rotationally fixed to the bit 20, thereby serving to transmit rotational force from the driver device to the bit 20 and effect drilling or fastening as needed.

A bit 20 can also be retracted from the locking tip 18 and returned to its space in the bit storage chamber 26 by reversing the method described above. Namely, the mid-chamber 6 is protracted out of the outer chamber 4, thereby retracting the central rod 8, dual lever arm magnetic end 32 and bit 20 back through the central bore 24. As the second end 38 of the dual lever arm 30 moves past shoulder 14, the biasing means 42 forces the second end 38 and the magnetic end 32 of the dual lever arm 30 to move radially outwardly, in opposite directions. The magnetic end 32, still magnetically linked to the bit 20, moves the bit 20 from the central bore 24 through slot 28 and back to its space in the bit storage chamber 26.

It is also possible to load bits into the locking tip 18 from sources other than the insert 2. Bits 20 can also be loaded into the first end 22 of the locking tip 18, in which case the same locking means 46 cooperate to hold the bit 20 from falling out. This method of loading advantageously allows the present component 2 to be used with a variety of bits 20 beyond those stored in the component 2.

The present invention can thereby accommodate bits in the locking tip 18 which may be significantly larger than those that can be accommodated in the bit storage chamber 26. Preferably the bit storage chamber 26 accommodates bits 20 of up to a 2″ size, whereas bits of sizes ranging from 2″ up to 4″ can be inserted from outside into the locking tip 18.

The bit storage chamber 26 of the present invention can advantageously be emptied and filled by the user, to load the component 2 with a desired magazine of bit types and sizes. To empty spaces in the bit storage chamber 26, the user simply loads bits 20 through the locking tip 18, as described above, and pulls the bits 20 out of the locking tip 18 to empty the bit storage chamber 26. Then new bits 20 can be inserted into the locking tip 18 and the component 2 can be protracted to its open position to pull the bits 20 back into the bit storage chamber 26.

In the foregoing specification, the invention has been described with a specific embodiment thereof; however, it will be evident that various modifications and changes may be made thereto without departing from the broader scope of the invention.

1. A component of a bit driving tool, said component comprising:
a. a mid-chamber, telescopically received in an outer chamber, the mid-chamber and the outer chamber surrounding a central bore;
b. a bit storage chamber formed in the mid-chamber, surrounding and rotatable about the central bore and comprising one or more bit storage compartments;
c. a central rod extending through and out of the outer chamber, said central rod being axially movable through central bore when the mid-chamber is telescopically retracted into the outer chamber; and
d. a dual lever arm comprising a first magnetic end; and a second end pivotably connected to the central rod such that the dual lever arm pivots into and out of axial alignment with the central bore;;
wherein telescopic extension of the mid-chamber out of the outer chamber positions the magnetic end of the dual lever arm to magnetically connect with a rear end of a bit stored in the bit storage chamber and telescopic retraction of the component pivots the magnetic end and the magnetically connected bit radially inwardly into the central chamber and wherein further telescope retraction of the component pushes the central rod, the dual lever arm, the magnetic end and the bit axially through the central chamber until the bit extends out of the component.

2. The component of claim 1, wherein telescopic extraction of the mid-chamber out of the outer chamber retracts the central rod, the dual lever arm, the magnetic end and the bit axially through the central bore and moves the dual lever arm and the magnetically connected bit radially outwardly from the central bore into a compartment of the bit storage chamber.

3. The component of claim 1, wherein the dual lever arm is biased radially outwardly towards the bit storage chamber by a biasing means.

4. The component of claim 3, wherein the biasing means comprises a spring.

5. The component of claim 3, further comprising a shoulder formed in the mid-chamber and wherein axial travel of the dual lever arm through the central bore guides the dual lever arm second end along said shoulder to overcome its radial outward bias and pivot radially inwardly into the central chamber.

6. The component of claim 1, wherein the magnetic end of the dual lever arm is pivotably connected to the dual lever arm to enable full contact between the magnetic end and the rear end of the bit during telescopic contraction of the mid-chamber into the outer chamber.

7. The component of claim 1, wherein the mid-chamber is rotatable when protracted out of the outer chamber.

8. The component of claim 7, wherein rotation of the mid-chamber serves to align a selected bit, stored in a compartment of the bit storage chamber, with the dual lever arm.

9. The component of claim 8, wherein the mid-chamber comprises identifying means for identifying bits.

10. The component of claim 9, wherein the identifying means comprises a transparent mid-chamber.

11. The component of claim 9, wherein the identifying means comprises a detent formed between the bit storage chamber and the mid-chamber.

12. The component of claim 1, wherein the mid-chamber is removable from the component.

13. The component of claim 1, wherein the drill component is rotatably received in one or more varieties of bit driving tools.

14. The component of claim 13, wherein the component is rotatably received by means of one or more ball bearings between the component and the bit driving tool.

15. The component of claim 1, further comprising a locking tip attached to the mid-chamber, from which the bit extends when the mid-chamber is retracted into the outer chamber.

16. The component of claim 15, wherein the mid-chamber comprises a tapered profile leading to the locking tip.

17. The component of claim 15, wherein the locking tip comprises a locking means for gripping the bit.

18. The component of claim 15, wherein bits are removable from the locking tip.

19. The component of claim 15, wherein bits are insertable into the locking tip.

20. The component of claim 1, further comprising a protrusion on said magnetic end that mechanically engages the bit.
